(19) United States
(12) Patent Application Publication
(10) Pub. No.: US 2016/0156993 A1
(43) Pub. Date: Jun. 2, 2016

(54) Data Processing Device

(71) Applicant: VIDDIGA, Paris (FR)

(72) Inventor: Sebastien Gilles, Sceaux (FR)

(21) Appl. No.: 14/896,932

(22) PCT Filed: Jun. 10, 2014
(86) PCT No.: PCT/FR2014/051377

§ 371 Date: Dec. 9, 2015

(30) Foreign Application Priority Data
Jun. 12, 2013 (FR) 1355433

(51) Int. Cl. H04N 21/835; H04N 21/854; H04N 21/234; H04N 19/467; H04N 21/254; H04N 21/4627

(52) U.S. Cl. CPC H04N 21/835; H04N 21/2541; H04N 21/4627; H04N 21/23418; H04N 19/467; H04N 21/85406

(57) ABSTRACT

Device for analyzing streaming audio-video data, characterized in that it comprises a selector (20) designed to determine input data relating to an audio stream or to a video stream in the streaming audio-video data, a converter (22) designed to produce image data at a frequency chosen on the basis of the input data, an encoder (24) designed to produce compressed data on the basis of the image data, and a projector (26) designed to produce imprint data on the basis of the compressed data, the converter (22) being designed to produce the image data in the form of an image of fixed dimension, the encoder (24) being designed to work successively on each image described by the image data, and the projector (26) being designed to produce the imprint data as a stream on the basis of the weight of the compressed data produced successively.

The invention relates to the field of data processing.

In many environments, the owners of media rights, whether audio or video for example, wish to be able to detect the broadcasting of media over which they hold rights. To this end, two large data processing families exist: fingerprinting and watermarking.

The best-known examples of use of these technologies pertain to the search for the use of content illegally broadcast over networks, or the detection of protected content on video sharing platforms, in order to propose to the right holder to have his content removed or to share with the platform the revenue generated by monetization of viewings of his content through advertising. Yet this represents only a relatively insignificant part of the requirements.

Indeed, many economic models of the valorization of owners' rights are based on a remuneration on the basis of the number of broadcasts by legitimate networks, such as radio or television channels. In the specific case of advertising, these contracts provide for the broadcasting of media according to a certain figure, and during certain time slots, against remuneration.

However, for various reasons, the schedules of radio and television channels are constantly being reshuffled, the schedule planned by the advertising agency is rarely, if ever, respected, and tradeoffs are carried out by the radio and television channels to meet their commitments.

Nevertheless, other than employing personnel for whom the sole duty is to monitor each and every radio and television channel involved in a given advertising campaign for a given company, it is not possible to verify whether the contracts have indeed been respected. What is more, these personnel would be employed either by a radio or television channel or by a company which has bought advertising space. They would therefore not be considered impartial.

Third parties have therefore filled the vacuum existing in relations between advertisers and radio or television channels, and these are known as trusted third parties. However, once again, these third parties need to be trustworthy, and their services are very costly.

There is therefore an historic need for a tool making it possible to make the relationship between advertisers and radio or television channels more objective.

It is difficult to fulfill this need through watermarking: indeed, the watermarking must be implemented from the production stage of the media in question, which is expensive and is difficult to make up for afterward. Additionally, the costs for detecting the watermark are very high, require intensive computation which is very resource consuming in a mobile environment, and the known watermarking techniques can be irreversibly degraded when the radio or television channel adjusts its signal for the program.

Regarding the methods for fingerprinting, they have a tendency to fail to maintain a satisfactory level of detection quality when scaling up (i.e. their ability to identify content significantly decreases as the volume of data to be identified significantly increases), or to perform inadequately, unless the cost of detection is too high to be able to do it in real time.

Beyond the problem described above, there is a need to make it possible for radio or television channels to be informed of their scheduling and/or their advertising in real time, in a wholly reliable manner, so as to be able to valorize the media for which the use is exponentially increasing and which are known as “second screen”.

Indeed, many radio or television channels make it possible for their listeners to use their tablet or their smartphone with an application with which they provide them in order to enrich their experience during a given program. Once again, the exact and instantaneous knowledge of the programming schedule actually broadcast by the radio or television channel is a substantial asset which is currently unavailable, but which would make it possible, for example, to broadcast targeted: advertisements on the second screen, advertisements for which it is well known that their value is 10 to 100 times greater than those of conventional banners.

Furthermore, it is often desirable for these applications to be able to authenticate the channel or the content watched by a viewer, for example in order to reserve use of the service for the users actually watching a given channel or given content.

The problem gets even trickier when taking into consideration the editors of mobile applications proposing “horizontal” applications across a group of channels, and no longer on one single channel in particular.

For all of these reasons, there is a need to offer an effective data processing device which makes possible the instantaneous and exact detection of an actual broadcast schedule for a radio or television channel.

The invention improves the situation.

To this end, the invention proposes a data processing device for streamed audio-video data, characterized in that it comprises a selector arranged to determine input data relating to an audio stream or to a video stream in the streamed audio-video data, a converter arranged to produce image data at a frequency chosen on the basis of the input data, an encoder arranged to produce compressed data based on the image data, and a projector arranged to produce fingerprinting data based on the compressed data, the converter being arranged to produce the image data in the form of an image of fixed size, the encoder being arranged to work successively on each image described by the image data, and the projector being arranged to produce the fingerprinting data as a stream on the basis of the weight of the compressed data produced successively.

According to other aspects, the device may also have the following features:
the converter is arranged to segment input data relating to an audio stream into successive sample windows, and to convert the input data of each window into successive image data by converting the amplitude of each sample into a grayscale value, the converter furthermore being arranged to produce image data of a given window in the form of an image in which successive pixels of a given row correspond to successive samples of the input data, each having a corresponding grayscale value, and in which the rows of the image are identical to each other,
the windows have a duration of 0.25 s, and are separated from each other by a number of samples making it possible to obtain image data at the chosen frequency,
the converter is arranged to select images in input data relating to a video stream depending on the chosen frequency, and to produce the image data by converting these images to a chosen size,
the chosen size is 120*160,
the encoder comprises a lossy image compressor,
the encoder functions by block processing and quantification,
the encoder comprises a compressor of the MEG family, or a compressor of WebP type,
the projector is arranged to produce the fingerprinting data by projecting, over a given range, the weight of the compressed data produced successively according to a chosen law of projection,
the range comprises the integers between 0 and 2.55, and the law of projection is linear.

Other features and advantages of the invention will become more readily apparent upon. reading the following description, derived from non-limiting examples given by way of illustration, derived from drawings in which:

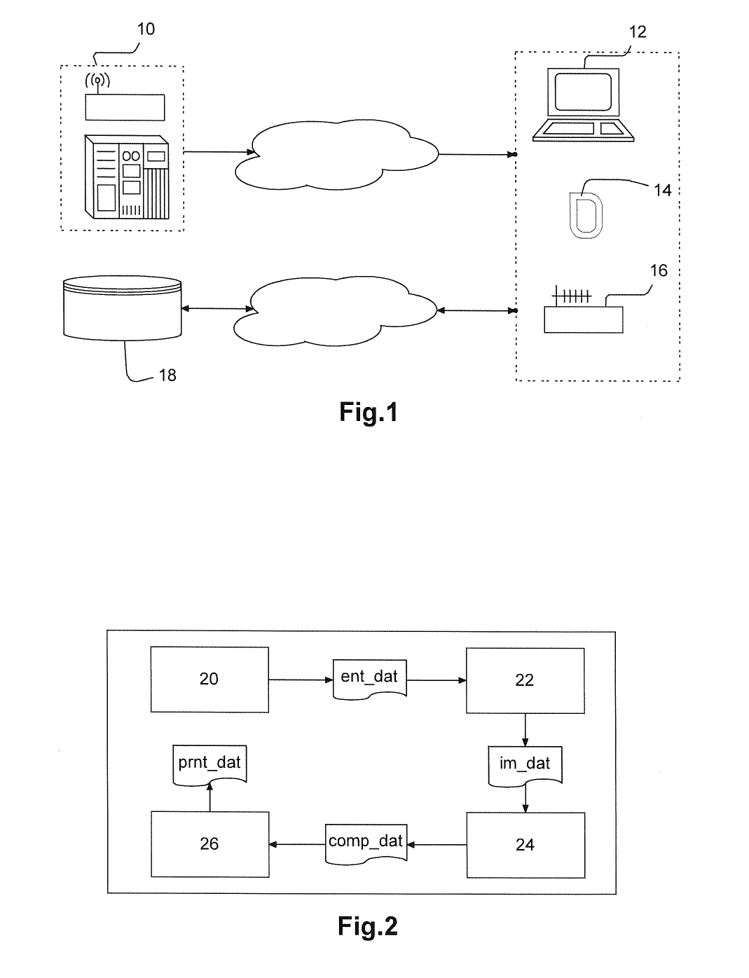

FIG. 1 shows an example of an implementation environment for a device according to the invention,

FIG. 2 shows a device according to the invention,

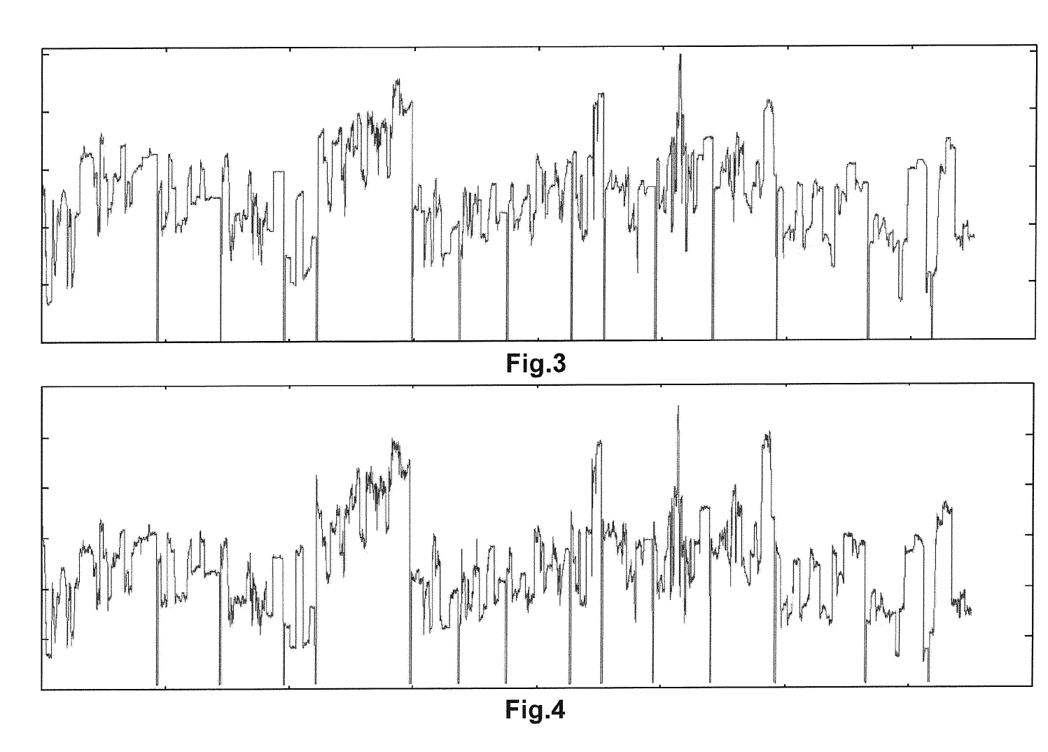

FIG. 3 shows an example of a fingerprint produced using a first encoding algorithm,

FIG. 4 shows an example of a fingerprint produced using a second encoding algorithm.

The drawings and the description hereinafter contain, in the main, elements of known character. They will therefore be able not only to serve to facilitate a better understanding of the present invention, but also to contribute to its definition, if necessary.

FIG. 1 shows an implementation environment for a device according to the invention.

In this environment, an owner transmits unmarked content from a content server 10. The transmitted content is received by users via various media consumption devices, such as a computer 12, a tablet 14 or a radio 16.

These media consumption devices are arranged to implement the device according to the invention, and to contact a fingerprinting server 18 to identify, in real time, the content received by a consumption device, and to send back to the latter a content identifier and/or other supplementary information, such as targeted advertisements.

The invention should be understood as being very broadly applicable, in the sense that:
the owner can transmit audio content (for example digital, terrestrial, or Internet radio, or any other provision of audio content), as well as video content (for example a television channel, a provider of VOD or of content via Internet such as YouTube or Dailymotion (trademarks), this content thus being globally categorized as audio-video, i.e. audio, video, or a combination of both.
the consumption devices can comprise any device suitable for implementing the device described using FIG. 2, whether it is (in addition to the devices already mentioned by way of example) a smartphone, a connected television, a connected settop box, a server dedicated to the analysis of content, or any other suitable device,
the content server can be connected to third-party servers for providing supplementary information on the identified content, or even be a black box simultaneously carrying out the identification of content and the determination of supplementary information.

As mentioned in the introduction, an effective solution in terms of costs and performance for the type of environment shown in FIG. 1 has long been sought. The invention solves this problem by virtue of a device which produces a robust, lightweight fingerprint at low computational cost.

The Applicant has noted that the known watermarking or fingerprinting solutions seek to categorize content individually, as if it were made up of autonomous entities, without taking its transmission environment into account. Consequently, the resulting watermarks and fingerprints are often strongly correlated with the content itself, and in fact represent a kind of simplification of the original content, ultimately quite close to the original. Starting from the principle that content is mainly transmitted and consumed as a stream in the framework of the applications pertaining thereto, the Applicant has sought to abstract the fingerprint generated, while strongly correlating it with the information transported by the content and without ending up with a “miniature” version of the original content.

These efforts have culminated in the device shown diagrammatically in FIG. 2, which will now be described.

The device according to the invention comprises a selector 20, a converter 22, an encoder 24 and a projector 26.

The function of the selector 20 is to demultiplex the original stream, i.e, to receive streamed audio-video data and to extract therefrom the audio or video track in order to form a stream of input data. The stream of input data contains exclusively audio data or exclusively video data. Thus, if the streamed audio-video data received pertains to an audio stream, then the selector 20 produces input data designating the amplitude of the successive samples of this audio stream. If the streamed audio-video data received pertains to a video stream, then the selector 20 produces input data corresponding to the audio stream of the video, along with input data corresponding to the image stream of the video, by demultiplexing. In a variant, the selector 20 can omit the production of input data corresponding to the image stream of the video.

The selector 20 calls the converter 22 with the input data ent_dat and at the output produces image data im_dat. This step is fundamental, and will he explained in greater detail below.

The converter 22 is arranged to produce the image data differently according to whether the input data relate to an audio stream or a video stream.

The converter 22 is arranged to produce successive images of fixed size from the input data.

In the case of input data relating to an audio stream, the converter 22 therefore receives a stream of input data, and cuts this input stream into successive windows. Each window contains a number of samples depending on the length of the window and on the sampling frequency of the audio stream corresponding to the input data. Each window will have corresponding image data defining an image at the output.

For each window, the converter 22 converts the amplitude of the successive samples into grayscale values in order to define a row of pixels the length of which corresponds to the number of samples in the window. Next, the row of pixels is repeated a number of times chosen to form the image corresponding to the window.

In the example described here, the row of pixels is copied eight times so that the size of the images produced is L*8, where L designates the number of audio samples in each window. Starting from an audio stream encoded at 44.1 kHz, of a window of 0.25 s, and for a fingerprint of frequency 25 Hz, we get:
windows each containing 11025 samples,
the successive windows being shifted by 1764 samples relative to each other,
images of size 11025*8.

When the audio stream of the input data has another sampling frequency, for example 48 kHz, the input data can be transformed to reduce them to 44.1 kHz, or the converter 2.2 can act by producing pixels the grayscale value of which takes this resampling into account, for example by extrapolation. When the audio stream contains multiple channels, the sampling can be based on one of the channels only, or on an average of the channels.

Calculating the grayscale value for each pixel depends on the quantification of the audio stream of the input data. In the example described here, the converter 22 produces images encoded in 256 shades of gray. Thus, if the input data represents a stream quantified over 16 bits, it will be necessary to project the amplitude of each sample from [0; 65536] to [0; 255]. In the example described here, the projection is linear. However, the projection can also be Gaussian, or any other suitable projection.

In the case in which the input data relate to a video stream, the converter 22 is arranged to produce successive images of fixed size. As a reminder, a video stream implements two main devices: a container (the role of which is to transport elementary packets of information) and a codec (the role of which is to encode and to decode the elementary packets). Whatever the type of container and video codec used by a stream, the elementary decompression of this stream gives rise to a series of temporally ordered images of fixed size (for example 1920×1080 for a TV signal in HD format), Nevertheless, a re-encoding of this stream for a mobile terminal (for example 720×576 pixels for a TV signal in SD format) will lead to images of different definition. Furthermore, other broadcasting parameters influence the final size of the elementary image of a stream, such as the addition of horizontal black bars to transform a 16:9 signal into a 4:3 signal. In order to remove the dependence of the subsequent processing steps on the size of the original image, this image is “resized” to a fixed size, independent of the input stream. This situation is quite conventional, and it is therefore a question of reducing an image of dimensions imparted by the video stream to a chosen format, 120*160 in the example described here.

In the case in which the images of the video stream of the input data have an aspect other than 120*160, the converter 22 can operate:
by cutting chosen parts of each image in order to recover the same aspect ratio as the images produced by the converter 22 (i.e. ¾), or
by extrapolating chosen parts of each image in order to recover the same aspect ratio as the images produced by the converter 22 (i.e. ¾), or by producing images the aspect ratio of which corresponds to that of the images of the input data, i.e. 120*(K*160) where K is an aspect compensation factor.

Like for the case in which the input data pertain to an audio stream, provision is made for a fingerprint stream to be produced at 25 Hz, The converter 22 is therefore arranged to select an image every 1/25^{th} of a second in the input data. In the case in which the video stream of the input data has a rate other than 25 images per second, for example at 30 images per second, the converter 22 can carry out an extrapolation of images surrounding each time marker at 25 Hz.

At the output, the converter 22 transmits the image data corresponding to each successive image drawn from the input data at the encoder 24. A function of the encoder 24 is to produce compressed data comp_dat which constitutes a compressed version of the image data. In the example described here, the encoder 24 is the standard PEG encoder, free, developed and distributed by the Independent PEG Group. In a variant, the encoder 24 could also be a WebP open source encoder developed by Google. A special feature of the encoder 24 is to carry out a lossy encoding which functions by block processing and quantification. Other image encoding algorithms having similar features may be considered.

At the output, the compressed data are transmitted to the projector 26. The projector 26 generates the fingerprinting data stream prnt_dat by taking the computational weights of the compressed data successively generated by the encoder 24, and by projecting them over th.e interval [0; 255]. in the example described here, the projection is linear. However, the projection can also be Gaussian, or any other suitable projection. FIGS. 3 and 4 show examples of fingerprints produced from a REG encoder for FIG. 3, and a WebP encoder for FIG. 4. Surprisingly, these fingerprints are almost superposable,

Use of the encoder 24 makes the fingerprinting data robust to the transmission noise of the stream defining the input data, and produces compressed data the weight of which is an intrinsic measure of the information quantity (in the sense of Shannon) borne by the image data. Thus the fingerprinting data are abstracted with respect to the input data, while at the same time being strongly linked therewith. Additionally, if fingerprinting data taken in isolation are not always discriminating, the fact that they are generated as a stream makes the fingerprint generating method particularly robust, repeatable and discriminating. Thus the fingerprint stream displays invariance with respect to transformations or losses which can affect an audio or video signal during its transmission and its playback (noise, re-encoding, resizing, change of colors, of contrast or of brightness) and a descriptive power making it possible to identify, uniquely, any extract from this stream. Lastly, the generating method is very inexpensive in terms of computation time, thus making it possible to generate a robust fingerprint in real time.

The conversion of a stream of input data relating to either an audio or video stream into successive image data may seem surprising. This is a major discovery on the part of the Applicant.

Indeed, it has been seen that the Applicant has oriented his research toward fingerprint generation while taking into account the fact that the content is transmitted in a stream. By doing so, he has discovered that it is advantageous to produce a fingerprint also in the form of a stream,

Continuing his research, the Applicant has identified that the basic elements of the stream (the images for a video stream and the sample windows for an audio stream) represent information of an instantaneous static/spatial nature. This discovery has however caused him to discard the fingerprint-generating video or audio encoders which intrinsically correlate the dements of the stream so as to take advantage of the redundancies between the successive basic elements of a stream.

It is in this way that the Applicant came to be interested in image compression algorithms such as PEG, which make it possible to reduce the noise while preserving only the “useful” quantity of the information, which is reflected by the variable weight of each image. This led him to the structure for conversion/encoding/projection of the weight which he has applied to the video streams. Continuing his research, the Applicant has also discovered that this advantage is obtained both in the case of an audio stream and a video stream, and that the audio or video nature of the stream for which the fingerprint is generated is of less importance than the fact that this stream transports information of a sequential and instantaneous nature.

The result is a fingerprint generation method which is very lightweight both from the point of view of the weight of the fingerprints generated and of the generation cost of the fingerprints.

In the foregoing, it is assumed that the streamed audio-video data are of a digital nature. In a variant, the device according to the invention may comprise an analog acquisition and digital conversion stage according to the recommended formats described above.

Similarly, the examples described here recommend an audio stream of input data at 44.1 kHz, with windows of 0.25 s, and for a stream of fingerprinting data at 25 Hz, and a video stream of input data at 25 images per second, with an aspect ratio of 3/4. These particular elements may vary depending on the desired applications.

Lastly, in addition to providing an automated trusted-third-party service, along with supplementary information and/or targeted advertisements, the device of the invention can also serve to detect the presence of illicit content when broadcasting over content-sharing platforms, through detection at the input before any sharing, thus offering high security to content hosts.

1. A device for analyzing streamed audio-video data, characterized in that it comprises a selector arranged to determine input data relating to an audio stream or to a video stream in the streamed audio-video data, a converter arranged to produce image data at a frequency chosen on the basis of the input data, an encoder arranged to produce compressed data based on the image data, and a projector arranged to produce fingerprinting data based on the compressed data, the converter being arranged to produce the image data in the form of an image of fixed size, the encoder being arranged to work successively on each image described by the image data, and the projector being arranged to produce the fingerprinting data as a stream on the basis of the weight of the compressed data produced successively.

2. The device as claimed in claim 1, in which the converter is arranged to segment input data relating to an audio stream into successive sample windows, and to convert the input data of each window into successive image data by converting the amplitude of each sample into a grayscale value, the converter furthermore being arranged to produce image data of a given window in the form of an image in which successive pixels of a given row correspond to successive samples of the input data, each having a corresponding grayscale value, and in which the rows of the image are identical to each other.

3. The device as claimed in claim 2, the windows have a duration of 0.25 s, and are separated from each other by a number of samples making it possible to obtain image data at the chosen frequency.

4. The device as claimed in claim 1, in which the converter is arranged to select images in input data relating to a video stream depending on the chosen frequency, and to produce the image data by converting these images to a chosen size.

5. The device as claimed in claim 4, in which the size chosen is 120*160.

6. The device as claimed in claim 1, in which the encoder comprises a lossy image compressor.

7. The device as claimed in claim 6, in which the encoder functions by block processing and quantification.

8. The device as claimed in claim 7, in which the encoder comprises a compressor of the JPEG family, or a compressor of WebP type.

9. The device as claimed in claim 1, in which the projector is arranged to produce the fingerprinting data by projecting, over a given range, the weight of the compressed data produced successively according to a chosen law of projection.

10. The device as claimed in claim 9, in which the range comprises the integers between 0 and 255, and in which the law of projection is linear.
